(19) United States
(12) Patent Application Publication
(10) Pub. No.: US 2007/0130878 A1
(43) Pub. Date: Jun. 14, 2007

(54) Line block for masonry

(76) Inventor: Dean J. Davis, Roanoke, VA (US)

Correspondence Address: LITMAN LAW OFFICES, LTD., P.O. BOX 15035, CRYSTAL CITY STATION, ARLINGTON, VA, 22215, US

(21) Appl. No.: 11/289,373

(22) Filed: Nov. 30, 2005

(51) Int. Cl. G01C 15/10

(52) U.S. Cl. 52/749.13; 52/747.12; 33/407; 33/408

(57) ABSTRACT

The masonry line block facilitates the alignment of standard masonry walls while providing clearance for the construction of quoin corner buildouts without need to relocate the corner pole set for alignment of the standard wall. The line block has a squared U shape, with a central side or leg and two opposed, parallel legs or sides extending therefrom. The space between the legs fits closely about a conventional masonry corner pole. One of the parallel legs is slightly longer than the other, with the width of the shorter parallel leg preferably being equal to their difference in length. The width of the short leg and their difference in lengths define the additional setback of the corner pole from the corner, and thus the width of the quoin buildout. A medial groove is provided about the device for the guide line, with guide line anchor screws provided in the central leg.

### BACKGROUND OF THE INVENTION

1. Field of the Invention

The present invention relates generally to gauges and the like used in the construction field. More specifically, the present invention is a masonry line block which is removably and adjustably attached to a pole, to which a guide line is attached for aligning a course of bricks or the like in the construction of a masonry wall.

2. Description of the Related Art

Masonry work, particularly the construction of brick walls and structures, requires a great deal of precision and accuracy on the part of the bricklayer or masonry worker in order to form structures which not only look good, but are also solid structurally. Accordingly, it is a universal practice when constructing such walls and structures to provide guide lines along the length(s) of the wall(s) being constructed in order to assure that they are straight and that each brick or block course is level and uniform. The guide lines comprise taut strings or cords which are stretched from corner to corner of the wall, between posts erected at the corners and positioned so as to be located at the outer corners of the masonry wall when it is completed.

A problem arises when the wall is to include something more than a plain, flat surface. For example, decorative quoin buildouts at the corners of masonry walls are well known and often used in masonry construction. However, when a corner pole or post is set at the location where the outer corner of the conventional wall will be located, it interferes with the outward extension of the quoin construction. Conventionally, the bricklayer must lay up several courses along the walls between corners, erecting scaffolding and/or other working structure as required as the construction proceeds. Once the walls have been formed between corners, he must then return to the corners to construct the quoins, again beginning from a level close to the surface and working up. This results in considerable additional effort on the part of the masonry worker, as he must climb and descend the scaffolding and/or ladder(s) at least a few times as the difference between the quoin corner height and the standard wall height increases during construction.

As a result, a number of devices have been developed in the past in attempts to simplify quoin construction and facilitate the layup of masonry walls with quoin corners. An example of such is found in German Patent Publication No. 10, 154,380 published on May 22, 2003 to Renate van Dyken. According to the drawings and English abstract, the device comprises a pair of tubular legs normal to one another, with a third leg normal to the first two. One of the legs includes a magnet(s) thereon. According to FIG. 3 of the drawings, the device is placed with one leg extending along and in contact with the wall at one corner of the construction. No provision is made for the attachment of alignment strings or lines to the device, nor does it fit about a corner pole or post.

In addition to the above German Patent Publication reference, the present inventor is aware of various devices which secure to a corner post and which provide for the attachment of a guide line thereto. However, those devices either (a) do not accurately define the space between the standard wall corner and the quoin corner buildout, (b) attach the alignment string or cord in a different manner from the present line block, and/or (c) require repositioning of the corner pole or lateral repositioning of the line block in order to construct a quoin corner.

None of the above inventions and patents, taken either singly or in combination, is seen to describe the instant invention as claimed. Thus, a line block for masonry solving the aforementioned problems is desired.

### SUMMARY OF THE INVENTION

The line block for masonry comprises a generally C-shaped device having squared corners and including three sides or legs. The device may be formed of any suitable material, e.g. metal, plastic, etc., and is preferably provided with a smooth and impervious surface in order to preclude adhesion of mortar thereto. The central side or leg has two opposed, parallel legs extending therefrom, with the internal spacing between the two opposed legs fitting closely about a conventional corner post or pole as used in masonry work. One of the two opposed legs is somewhat shorter than the other, with at least the shorter leg having a width preferably equal to the difference in length between the two opposed legs. The width of the shorter leg and the difference in length between the two opposed legs defines a quoin corner buildout dimension, i.e. the difference between the standard wall and the extended quoin corner buildout. In most cases, this is about ¾ inch, but the dimensions provided by the present line block may be adjusted as desired to provide any practicable quoin buildout as desired.

The present line block serves as an anchor point for the guide line used to align the conventional wall. However, the width of the two opposed legs, and the difference in length of the two opposed legs, results in the corner post or pole being set back slightly farther from the corner of the wall than is normally the case. This allows spacing between the corner pole and the conventional wall for the quoin corner buildout, without requiring the corner pole to be relocated. The line block is moved progressively up the corner pole as each course of bricks or masonry is laid and enables the quoin corner to be constructed at the same time as the standard wall, i.e. each quoin course is laid at the same time and on the same course as the standard wall construction. This eliminates the need for the masonry worker(s) to climb up and down the scaffolding and/or ladder(s) erected as the height of the wall increases, to move back and forth between the standard wall and quoin corner construction as the difference in their heights and number of courses increases during the construction process.

These and other features of the present invention will become readily apparent upon further review of the following specification and drawings.

### BRIEF DESCRIPTION OF THE DRAWINGS

FIG. 1 is an environmental, perspective view of the line block for masonry installed upon a corner pole for the construction of a masonry wall and quoin corner, in accordance with the present invention.

FIG. 2 is a top plan view in slightly reduced scale of the present line block for masonry installed upon a corner pole, with a guide line extending around the line block and showing the alignment of the guideline with the standard wall and the alignment of the inner corner of the corner pole with the quoin corner buildout.

FIG. 3A is a detailed inboard perspective view of the present line block, showing various details thereof.

FIG. 3B is a detailed outboard perspective view of the present line block, showing further details thereof.

Similar reference characters denote corresponding features consistently throughout the attached drawings.

### DETAILED DESCRIPTION OF THE PREFERRED EMBODIMENT

The present invention comprises a line block for use in the alignment of masonry walls and quoin corner buildouts during construction. While the present line block for masonry is particularly well adapted for use in constructing brick walls and quoin corners, it may also be adapted for use in the construction of concrete block and/or other types of masonry walls as well.

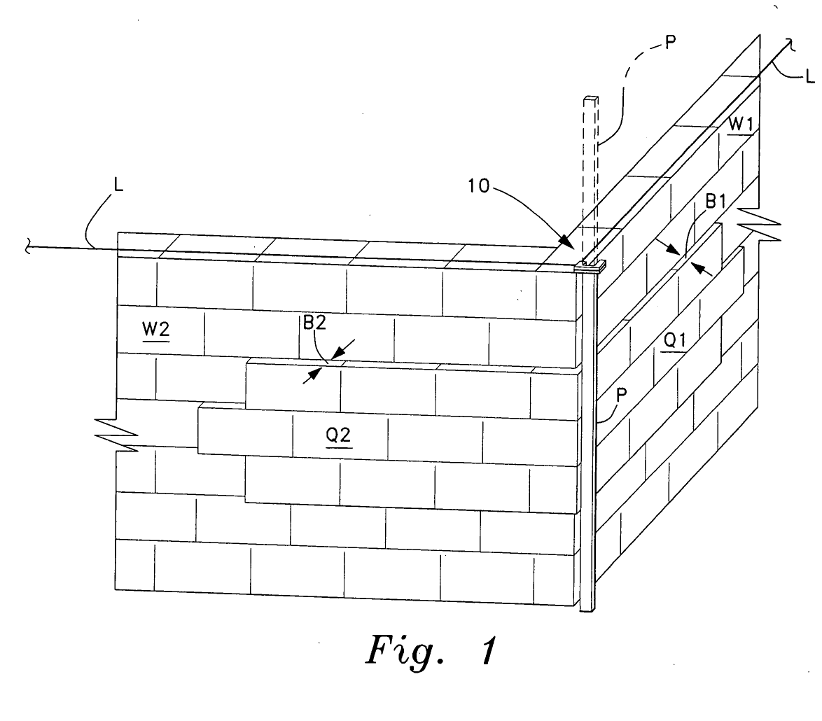

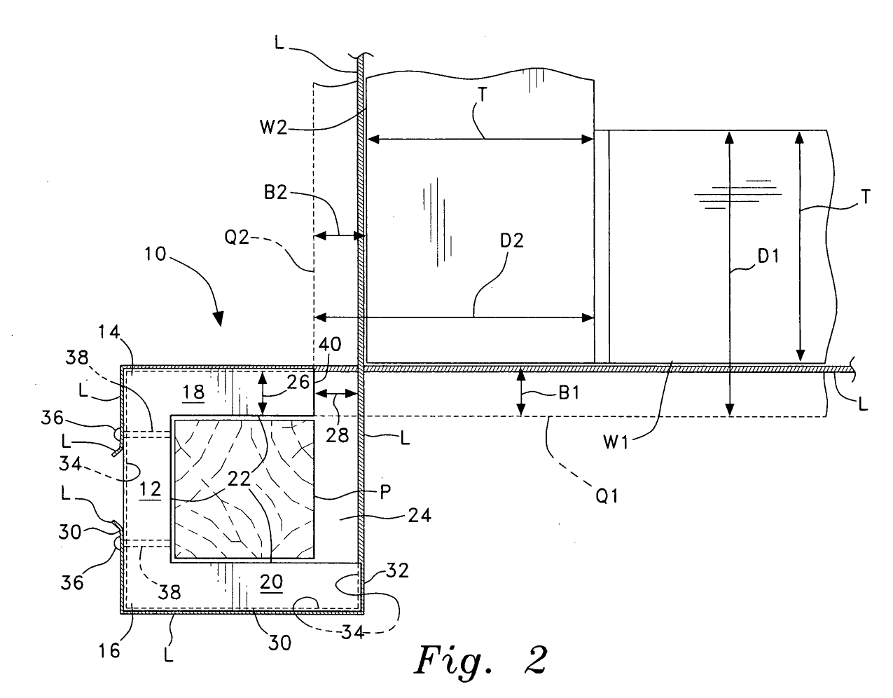

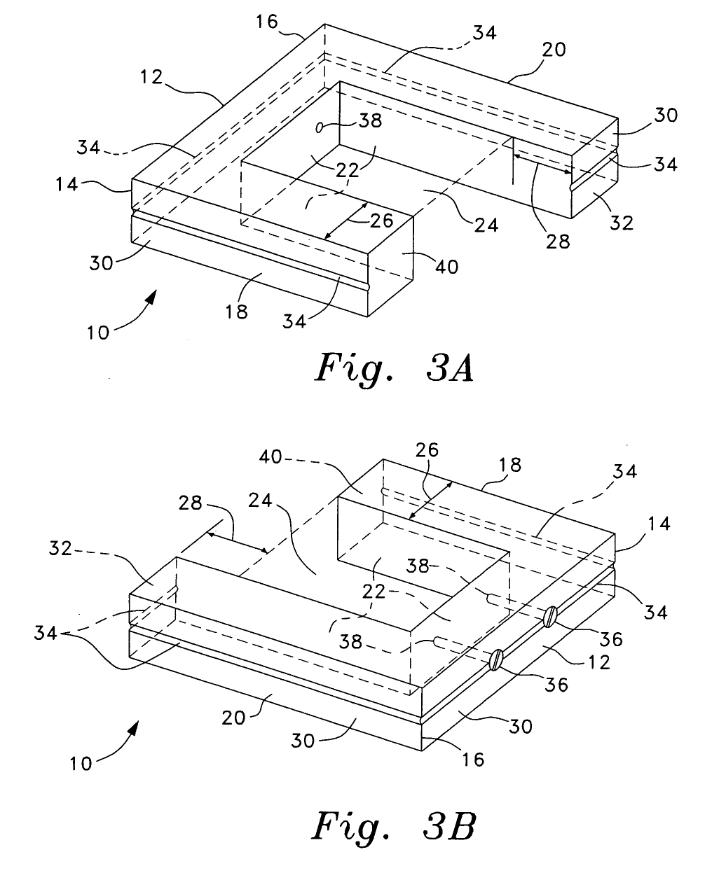

FIG. 1 of the drawings provides an environmental perspective view of a masonry wall being constructed with the use of the present line block, with FIG. 2 providing a detailed top plan view of the line block installation of FIG. 1 and FIGS. 3A and 3B providing detailed perspective views of the line block device. Attention is initially directed to FIGS. 3A and 3B for a detailed description of the device.

The line block 10 includes a central first leg 12 having a first end 14 and an opposite second end 16. A second leg 18 extends from the first end 14 of the first leg 12, with a third leg 20 extending from the opposite second end 16 of the first leg 12. The second and third legs 18 and 20 are normal to the first leg 12 and parallel to one another, with the three legs 12, 18, and 20 defining a plane and comprising a rectilinear, generally U-shaped configuration. The three legs 12, 18, 20 include an interior surface 22 which defines a corner pole passage 24 therebetween, functioning generally as shown in FIG. 2. Conventional corner poles or posts P used to define the corners of masonry walls are formed of metal or wood, nominally two inches square in cross section. Accordingly, the line block 10 may span two inches between the inner surfaces 22 of the two opposed legs 18 and 20, with the interior length of the shorter second leg 18 extending for two inches from the interior of the first leg 12. Thus, the shorter second leg 18 extends along one complete side of the corner pole P, with the opposite longer third leg 20 extending somewhat beyond the opposite side of the corner pole P for reasons explained further below. It will be recognized that the present line block 10 may be formed to have other interior dimensions to fit corner poles P of other than a two inch by two inch cross section, if so desired.

The present line block 10 may be used for the attachment and support of a guide line for the alignment of a conventional, plain masonry wall, if so desired. However, the line block 10 is particularly well suited for use in the alignment of masonry walls having quoin corner buildouts, e.g. the structure illustrated in FIG. 1 and described in detail further below. A quoin corner, by definition, is built out slightly (e.g., ¾ inch or so) from the vertical plane of the conventional masonry wall. Conventionally, corner poles are set out diagonally from the base wall (plywood or particle board sheathing, etc.) a distance equal to the horizontal thickness or width of the bricks or other masonry to be used in the construction of the wall. Thus, the quoin corner cannot be constructed during the construction of the standard masonry wall, as the corner post would interfere with the quoin corner buildout. Instead, most of the standard masonry wall is constructed with the corner construction delayed until the corner pole can be removed and realigned (if required) for the construction of the quoin corner. This multiple step operation, along with numerous trips up and down any ladders and/or scaffolding which may have been erected, is time consuming and tiring for the masonry workers involved.

The present line block 10 allows the corner pole to be set back from the base wall sufficiently to allow the construction of the quoin corner buildout without need to remove and relocate the corner pole and allows the quoin corner to be constructed simultaneously with the standard masonry wall, course by course. This is accomplished by two specific dimensions provided by the present line block 10, with the two specific dimensions being equal to the lateral width of the quoin corner buildout along the two walls defining the corner of the masonry structure. The short second leg 18 of the line block 10 is specifically configured to have a width 26 which defines a quoin corner first side buildout width B1 along the first wall W1 of a structure, as shown in FIG. 2. Also, the difference 28 in length between the second and third legs 18 and 20 defines a quoin corner second side buildout width B2 along the second wall W2 of the masonry structure. (It will be noted that the line block 10 is inverted in FIGS. 3A and 3B, relative to its installation at the corner of walls W1 and W2 in FIGS. 1 and 2. The line block 10 is merely inverted as required to provide a mirror image orientation, depending upon which side or end of a wall it is to be used with.)

Conventionally, quoin corner buildouts, e.g. B1 and B2, extend laterally from the respective conventional masonry wall W1 and W2 by about ¾ inch, with the two buildout widths B1 and B2 being equal to one another. Accordingly, the width 26 of the second leg 18 of the line block 10 has a corresponding width of ¾ inch and the difference 28 in the lengths of the second and third legs 18 and 20 is also ¾ inch. These two dimensions 26 and 28 define the lateral buildout extension width B1, B2 of the quoin corner structure. While the ¾ inch buildout width is standard, it will be recognized that other quoin corner extension widths may be readily achieved by adjusting the width 26 of the second leg 18 of the device and the difference 28 in the lengths of the two parallel legs 18 and 20. Moreover, it is not an absolute requirement that the two dimensions 26 and 28 of the present line block 10 be equal, if it is desired to provide unequal quoin corner buildout widths B1 and B2. However, equal widths B1 and B2 are preferred for symmetry in the masonry structure.

The present line block 10 is used generally as shown in FIGS. 1 and 2. Initially, the corner pole P is set at distances D1 and D2 outwardly from the base wall structure, with the distances D1 and D2 being equal to the horizontal width or thickness T of the bricks or other masonry to be used, plus the additional horizontal width or thickness B1, B2 of the quoin corner buildout along each side of the wall. Conventionally, this results in a setback for the corner pole P of 4½ inches for the horizontal thickness T of a brick masonry wall plus ¾ inch for the horizontal thickness of the quoin corner buildout B1, B2, for total setback distances D1, D2 of 5¼ inches each. Again, the setback distances D1, D2 for the corner pole P may be adjusted as desired, depending upon the horizontal thickness of the bricks or other masonry being used and the lateral extension width of the quoin corner to be constructed.

Once the corner pole P has been anchored in place, the line block 10 is placed thereon. The first leg 12 is oriented parallel to the (intended but not yet constructed) second wall W2, while the second and third legs 18 and 20 are oriented parallel to the (to be constructed) first wall W1, with the second leg 18 closer to the first wall W1 than the third leg 20. This arrangement is shown in the top plan view of FIG. 2. Again, the device 10 is merely inverted to provide a mirror image orientation, depending upon which end or corner of the wall it is being used with. Initially, the line block 10 is placed relatively low on the corner pole P, i.e. even with the lowermost or first course of masonry to be laid.

At this point, a guide line L is extended along the two wall outlines W1 and W2, and passed completely around the outer circumference or external surface 30 of the line block 10. The line L crosses itself at a point defined by the exterior surface 30 of the second leg 18 and the flat end 32 of the third leg 20, i.e. at the precise outer corner of the to be constructed masonry wall, and continues parallel to the first and second walls W1 and W2. The external surface 30 is normal to the plane defined by the three legs 12, 18, and 20 of the device. A single, continuous, shallow guide line groove 34 extends about the flat external surface 30 and across the flattened end 32 of the longer third leg 20 (square or normal to the external surface 30 and plane of the legs), to hold the guide line L securely therein. The guide line groove 34 preferably has a width substantially equal to the diameter or width of the conventional masonry guide line L in order to locate the guide line L precisely about the median of the line block 10, and a depth substantially equal to one half of its width or the width or diameter of the guide line L, as shown in the top plan view of FIG. 2. This positions the guide line L at the outer surface 30 of the line block 10, thus assuring that the positioning of the corner pole at distances or dimensions D1 and D2 from the interior corner of the to be constructed masonry walls W1 and W2 will result in the guide line L being positioned precisely in alignment with the outer surfaces of the masonry walls W1 and W2.

The guide line L is anchored or secured to the line block 10 by at least one threaded guide line anchor screw 36 (e.g., machine screw, etc.) which adjustably and removably threads into a correspondingly threaded anchor passage 38 formed along the guide line groove 34, e.g. along the central leg 12 of the device. Preferably a pair of such anchor passages 38 and screws 36 are provided as shown in FIGS. 2 and 3B to facilitate the independent attachment of two different lengths of guide line L, although one such anchor screw 36 and passage 38 may be sufficient.

Once the guide line L has been, strung from the line block 10 to define the outer surface of the masonry wall(s) to be constructed, the first course of bricks or other masonry is laid, with the outer surface of the course being aligned with the guide line L as positioned by the present line block 10. The line block 10 is raised incrementally to the level of the next course, as each course is completed. Preferably, one such line block 10 is provided at each corner of the structure, with each line block being raised as each masonry course is completed in order to keep the guide line L level.

As the brick or masonry course approaches the corner of the two walls W1 and W2, allowance must be made for the construction of the quoin corner. At this point, the bricklayer or masonry worker need only build the quoin masonry out to align with the inboard sides of the corner pole P, i.e. with the inner surface 22 of the second leg 18 of the line block 10 for the first wall quoin Q1 and the flat end 40 of the shorter second leg 18 of the line block 10 for the second wall quoin Q2. The horizontal thickness or width 26 of the second leg 18 defines the first quoin Q1 buildout width or spacing B1, while the difference 28 in the lengths of the second and third legs 18 and 20 of the line block 10 defines the second quoin Q2 buildout width B2, as explained further above. This allows each course of the quoin to be laid evenly with the same course for the standard, non-quoin wall, without need for the masonry worker to climb up and down scaffolding and ladders several times to construct the standard wall and then return to build up the quoin corner, as is conventionally done in the trade. When the quoin corner course has been completed as described above, the masonry worker need only adjust the position(s) of the line block(s) upwardly along its (their) corner pole(s) to the level of the next course, and continue as described above.

In conclusion, the present line block for masonry greatly facilitates the job of a bricklayer or masonry worker in the construction of a masonry wall, particularly such a wall having a quoin corner. The present line block is of simple construction, preferably being formed as a single, unitary, monolithic, homogeneous structure. A number of different materials may be used to cast or otherwise form the present line block, with various metals perhaps providing the greatest durability. While steel or other ferrous metals may be used, a non-ferrous metal such as aluminum provides lighter weight and greater corrosion resistance. Preferably, the line block is provided with a smooth and liquid impervious outer surface in order to resist mortar adhesion. This may be accomplished by polishing the surface where metal is used to form the device, or forming the device of a hard, smooth, reasonably dense plastic material. Alternatively, a metal line block could be coated with a plastic having poor adhesion qualities, e.g. Teflon®, Nylon®, etc. In any event, the present line block for masonry will prove to be a most valuable tool for bricklayers and other masonry workers who have occasion to construct masonry walls with quoin corners.

It is to be understood that the present invention is not limited to the embodiment described above, but encompasses any and all embodiments within the scope of the following claims.

I claim:

1. A line block for masonry, comprising:
a central first leg having a first end and a second end opposite the first end;
a second leg extending from the first end of said first leg, and normal thereto;
a third leg extending from the second end of said first leg, and parallel to said second leg;
said first leg, said second leg, and said third leg defining a plane comprising a rectilinear, generally U-shaped configuration having an interior surface defining a corner pole passage therebetween;
at least said second leg having a width defining a quoin corner first side buildout width, and a length; and
said third leg having a length greater than the length of said second leg, with the difference in the length between said second leg and said third leg being equal to the width of said second leg and defining a quoin corner second side buildout width, whereby the quoin corner first side buildout width and quoin corner second side buildout width are equal to one another.

2. The line block for masonry according to claim 1, wherein:
said first leg, said second leg and said third leg each further include a flat external surface normal to the plane of said legs;
said third leg further includes a flat end normal to the flat external surface thereof and to the plane of said legs; and
the flat external surface of said first leg, said second leg, and said third leg, and the flat end of said third leg each further include a single shallow continuous guide line groove formed therein, the guide line groove having a width substantially equal to a masonry guide line and a depth substantially half the width.

3. The line block for masonry according to claim 2, wherein:
said first leg further includes at least one guide line threaded anchor passage therein, disposed along said guide line groove; and
said first leg further includes at least one guide line threaded anchor adjustably and removably disposed within said threaded anchor passage.

4. The line block for masonry according to claim 1, further including:
at least one corner pole; and
at least one guide line.

5. The line block for masonry according to claim 1, wherein said first leg, said second leg, and said third leg are formed as a single, unitary, monolithic, homogeneous structure of materials selected from the group consisting of plastic, non-ferrous metals, and ferrous metals.

6. The line block for masonry according to claim 1, wherein said first leg, said second leg, and said third leg all include a smooth, impervious outer surface resistant to mortar adhesion.

7. A method of constructing a quoin masonry corner using the apparatus of claim 1, comprising the steps of:
(a) forming a single continuous guide line groove along the exterior surfaces of the first, second, and third legs and a flat end of the third leg;
(b) setting a corner pole diagonally outwardly from a building corner defined by a first wall and a second wall normal thereto, by a distance equal to the thickness of the masonry structure and quoin corner buildout to be constructed along each wall defining the corner;
(c) placing the line block on the pole such that the first leg is parallel to the second wall and the second and third legs are parallel to the first wall, with the second leg closer to the first wall than the third leg;
(d) placing a guide line within the guide line groove such that the guide line crosses itself at a point defined by the exterior surface of the second leg and the flat end of the third leg, and continues parallel to the first and second walls;
(e) laying up a course of masonry along each wall, guided by the guide line;
(f) laying up a course of a quoin corner by aligning the exterior of the quoin corner with the internal surface of the second leg and the flat end of the third leg; and
(g) periodically raising the line block on the corner pole as required for succeeding courses of masonry.

8. A line block for masonry, comprising:
a single, unitary, monolithic, homogeneous structure having a first leg, a second leg, and a third leg forming a rectilinear, generally U-shaped configuration defining a plane, said second leg and said third leg being parallel to one another with said third leg being longer than said second leg;
said first leg, said second leg, and said third leg each further including a flat external surface normal to the plane of said legs;
said third leg further including a flat end normal to the flat external surface thereof and to the plane of said legs; and
the flat external surface of said first leg, said second leg, and said third leg, and the flat end of said third leg each further including a single shallow continuous guide line groove formed therein, the guide line groove having a width substantially equal to a masonry guide line and a depth substantially half the width.

9. The line block for masonry according to claim 8, wherein:
each said leg has an interior surface defining a corner pole passage therebetween;
at least said second leg has a width defining a quoin corner first side buildout width, and a length; and
said third leg has a length greater than the length of said second leg, with the difference in the length between said second leg and said third leg being equal to the width of said second leg and defining a quoin corner second side buildout width, whereby the quoin corner first side buildout width and quoin corner second side buildout width are equal to one another.

10. The line block for masonry according to claim 8, wherein:
said first leg further includes at least one guide line threaded anchor passage therein, disposed along said guide line groove; and
said first leg further includes at least one guide line threaded anchor adjustably and removably disposed within said threaded anchor passage.

11. The line block for masonry according to claim 8, further including:
at least one corner pole; and
at least one guide line.

12. The line block for masonry according to claim 8, wherein said first leg, said second leg, and said third leg are formed of materials selected from the group consisting of plastic, non-ferrous metals, and ferrous metals.

13. The line block for masonry according to claim 8, wherein said first leg, said second leg, and said third leg all include a smooth, impervious outer surface resistant to mortar adhesion.

14. A method of constructing a quoin masonry corner using the apparatus of claim 8, comprising the steps of:
(a) setting a corner pole diagonally outwardly from a building corner defined by a first wall and a second wall normal thereto, by a distance equal to the thickness of the masonry structure and quoin corner buildout to be constructed along each wall defining the corner;
(c) placing the line block on the pole such that the first leg is parallel to the second wall and the second and third legs are parallel to the first wall, with the second leg closer to the first wall than the third leg;
(d) placing a guide line within the guide line groove such that the guide line crosses itself at a point defined by the exterior surface of the second leg and the flat end of the third leg, and continues parallel to the first and second walls;
(e) laying up a course of masonry along each wall, guided by the guide line;
(f) laying up a course of a quoin corner by aligning the exterior of the quoin corner with the internal surface of the second leg and the flat end of the third leg; and
(g) periodically raising the line block on the corner pole as required for succeeding courses of masonry.

15. A method of constructing a quoin masonry corner, comprising the following steps:
(a) setting a corner pole diagonally outwardly from a building corner defined by a first wall and a second wall normal thereto, by a distance equal to the thickness of the masonry structure and quoin corner buildout to be constructed along each wall defining the corner;
(b) providing a line block having a first leg, a second leg, and a third leg forming a rectilinear, generally U-shaped configuration defining a plane, the second and third legs being parallel to one another with the third leg being longer than the second leg, each leg each further including a flat external surface normal to the plane of the legs, the third leg further including a flat end normal to the flat external surface thereof and to the plane of the legs, the flat external surface of each leg and the flat end of the third leg further including a single shallow continuous guide line groove formed therein;
(c) placing the line block on the pole such that the first leg is parallel to the second wall and the second and third legs are parallel to the first wall, with the second leg closer to the first wall than the third leg;
(d) placing a guide line within the guide line groove such that the guide line crosses itself at a point defined by the exterior surface of the second leg and the flat end of the third leg, and continues parallel to the first and second walls;
(e) laying up a course of masonry along each wall, guided by the guide line;
(f) laying up a course of a quoin corner by aligning the exterior of the quoin corner with the internal surface of the second leg and the flat end of the third leg; and
(g) periodically raising the line block on the corner pole as required for succeeding courses of masonry.
